(19) United States
(12) Patent Application Publication
(10) Pub. No.: US 2012/0089409 A1
(43) Pub. Date: Apr. 12, 2012

(54) APPARATUS, METHOD, AND SYSTEM TO TRACK GOODS AND SERVICES

(76) Inventors: Uttam Pawar, Portland, OR (US); Ravindranath Naiknaware, Portland, OR (US)

(21) Appl. No.: 13/250,922

(22) Filed: Sep. 30, 2011

Related U.S. Application Data
(60) Provisional application No. 61/389,150, filed on Oct. 1, 2010.

(51) Int. Cl. G06Q 99/00

(52) U.S. Cl. 705/1.1

(57) ABSTRACT

Embodiments herein describe an apparatus, method, and system to track goods and services. The tracked information is provided dynamically and in real-time to an end-user of the tracking system. The tracked information can be centrally managed by a server, or can be managed in a distributed network (e.g., cloud), or by a smart device (e.g., smart-phone, tablet PC). The method comprises: storing information in a database, the information corresponding to the good or service being tracked for an end-user; determining an update to the information stored in the database; determining whether a time attribute associated with the good or service exceeds a predetermined threshold; and generating an electronic message for the end-user of the good or service in response to determining the update or when the predetermined threshold exceeds the time attribute.

### CLAIM OF PRIORITY

The present patent application claims priority to and incorporates by reference the corresponding provisional Patent Application Ser. No. 61/389,150, titled, “APPARATUS, METHOD, AND SYSTEM TO TRACK GOODS AND SERVICES” filed on Oct. 1, 2010.

### FIELD OF THE INVENTION

Embodiments of the invention relate generally to the field of computers. More particularly, embodiments of the invention relate to an apparatus, method, and system to track goods and services.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2011, Invariant Technology LLC, All Rights Reserved.

### BACKGROUND

Consumers and producers buy goods and services regularly and are unable to track various aspects of those goods and services. For example, a warranty service offered by a manufacturer of a good may expire on a certain date without real time notification to the purchaser of that good. Likewise, perishable and non-perishable items owned or used by a user expire at different times and consumers of such items may unnecessarily expunge such items because of uncertainty regarding the expiration useful life) of such items. Such unnecessary expunging of items may be due to human nature to forget and/or the lack of any coordinated intelligent system to track multiple and heterogeneous goods and services in real-time.

The problem of tracking goods and services are further compounded because there are too many dates associated with an item to track when that item leaves a manufacturing facility and makes it to an end user. For example, a gallon of milk may have multiple dates to keep track of from the producer's and user's perspective, i.e. sell by date, use by date, use by number of days after opening, etc.

Expiration date tracking in a household is typically done in an ad-hoc manner and is prone to errors. Traditional systems such as calendar reminders and checklists are not suitable for expiration date tracking of day-to-day items due to the manual nature of the process. Irrespective of the fact that the checklists and calendar based systems can be electronic, the manual nature of the process continues to be arduous, time-consuming, and prone to errors. Furthermore, checklists and calendar based systems do not integrate well to facilitate expiration date tracking from manufacturing until it is consumed by the user or reaches the end-of-life.

In enterprise situations, checklists are exclusively used to monitor the expiration dates. However, the manual nature of the process to track the expiration date of goods and services continues to be costly. In restaurants, for example, the time-of-delivery of raw goods is exclusively monitored by the suppliers to ensure the quality of the raw goods. However, once the raw goods and/or items arrive at their destination point, the onus of monitoring the environment and the associated expiration dates of those raw goods and/or items switch to the local restaurants' specific manual processes.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1A illustrates a system model to track goods and services, according to one embodiment of the invention.

FIG. 1B is a high level flowchart to track goods and services, according to one embodiment of the invention.

FIG. 1C is time-line indicating various time attributes and update information associated with the good or service that are stored in a database, according to one embodiment of the invention.

FIG. 2 illustrates a method flowchart to track goods and services, according to one embodiment of the invention.

FIG. 3 illustrates a method flowchart of a payment system to enable tracking of goods and services, according to one embodiment of the invention.

FIG. 4 illustrates a method flowchart of a reminder system to remind a user or an entity about the goods and services being tracked, according to one embodiment of the invention.

FIG. 5 illustrates a method flowchart of a reminder signup system for tracking of goods and services, according to one embodiment of the invention.

FIG. 6 illustrates a method flowchart of a user system to track goods and services, according to one embodiment of the invention.

FIG. 7 illustrates a usage model to track pharmaceutical goods and services, according to one embodiment of the invention.

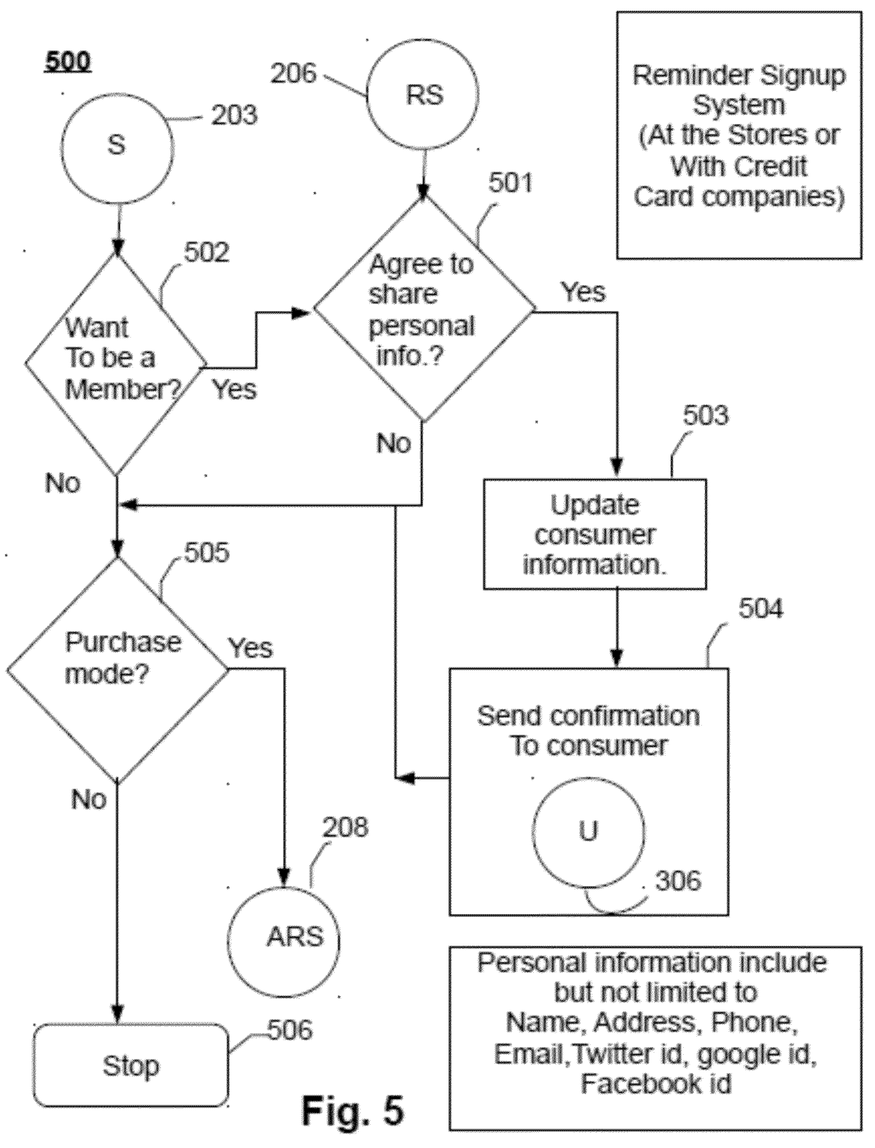

FIG. 5A illustrates a machine executable medium to execute the method flowcharts to track goods and services, according to one embodiment of the invention.

FIG. 8B illustrates the machine executable medium to execute the method flowcharts to track goods and services, according to one embodiment of the invention.

FIG. 8C illustrates the machine executable medium to execute the method flowcharts to track goods and services, according to one embodiment of the invention.

FIG. 8D illustrates the machine executable medium to execute the method flowcharts to track goods and services, according to one embodiment of the invention.

FIG. 5E illustrates the machine executable medium to execute the method flowcharts to track goods and services, according to one embodiment of the invention.

FIG. 8F illustrates the machine executable medium to execute the method flowcharts to track goods and services, according to one embodiment of the invention.

FIG. 8C illustrates the machine executable medium to execute the method flowcharts to track goods and services, according to one embodiment of the invention.

FIG. 8H illustrates the machine executable medium to execute the method flowcharts to track goods and services, according to one embodiment of the invention.

FIG. 9 illustrates a computer system having a machine executable medium to execute the method flowcharts to track goods and services, according to one embodiment of the invention.

### DETAILED DESCRIPTION

Embodiments of the invention relate generally to the field of computers. More particularly, embodiments of the invention relate to apparatus, method, and system to track goods and services. The apparatus, method and system discussed herein are not limited to food, pharmaceuticals, fire safety equipment, defibrillators, cosmetics, warranties, recalls, etc, hut can apply to track any good or service (e.g., legal contracts, labor guarantees, warranties).

In one embodiment, the apparatus, method and system discussed herein is operable to intelligently track, store, and remind end-users (computers and/or individuals) the expiration dates of various items and/or services. In one embodiment, the apparatus, method and system comprise a combination of hardware and software.

In one embodiment, the apparatus, method, and system comprise advanced logistical systems to track items from the manufacturing facility (production point) to the stores (point of sale). In one embodiment, the apparatus, method, and system comprise a Radio-Frequency Identification (RFD) tool that includes thermal, humidity, shock and position (including GPS and ground-based triangulation) sensors to identify the integrity of goods during the process of transportation from the manufacturing facility (production point) to the stores (point of sale).

In one embodiment, the apparatus, method, and system comprise a bar code system to track goods at the manufacturing facility and the stores. In one embodiment, the bar code system includes thermal, humidity, shock and position sensors including Global Positioning System (GPS) and ground-based triangulation sensors to identify the integrity of the goods during the process of transportation of such goods. The above embodiments having the bar code and/or the RFID tools provide information regarding the origin of goods and services, and correspondingly in one embodiment the apparatus, method, and system are operable to use the bar code and/or RFID tools to determine the wellness and/or expiration of goods and services.

In one embodiment, the apparatus, method, and system are operable to provide tracking data to an end-user of a good or service purchased at a point of sate e.g., a store. In one embodiment, the apparatus, method, and system comprise a handheld computing device which is operable to provide real-time tracking information of the goods and services bought by an end-user or inquired by an end-user.

In one embodiment, the apparatus, method, and system are operable to provide an automatic mechanism to track goods and services without any manual process. In one embodiment, the system (also called the tracking system) is operable to maintain a database of all goods and services that an end-user intends to track. In one embodiment, the database information about the goods and services is spread on a distributed network. In one embodiment, the database information about the goods and services is stored on a central server. In one embodiment, the apparatus, method, and system are closely integrated to a customer-accessible information system.

In one embodiment, the customer-accessible information system is configured to be minimally intrusive, i.e. it can provide or update tracking information of goods and services via a user friendly electronic interface. In one embodiment, the customer-accessible information system is operable to be accessed via smart-phones, handheld devices, and/or other intelligent terminals.

Furthermore, the customer-accessible information system is configured to provide collective information to a set of individuals. In one embodiment, the tracking system sends the update to members of the end-user 104, wherein the members of the end-user are identified with a common attribute among the members. For example, all members of a family residing in single dwelling may receive the collective information regarding the tracking of the goods and services associated with any member of the fan fly. In the above example, the common attribute is a single dwelling and blood relationship. In one embodiment, the set of individuals comprises restaurants, rehabilitation centers, hospitals, hostels, dormitories, adult care providers, etc.

In one embodiment, the apparatus, method, and system is operable to prompt a user via a graphical user interface of a handheld device (e.g., smart-phone, tablet PC, etc.) with tracking information e.g., expiration dates of goods and services.

In the following description, numerous details are discussed to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

In the following description and claims, the term “coupled” and its derivatives may be used. The term “coupled” herein refers to two or more elements which are in direct contact (physically, electrically, magnetically, optically, etc.). The term “coupled” herein may also refer to two or more elements that are not in direct contact with each other, but still cooperate or interact with each other.

As used herein, unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

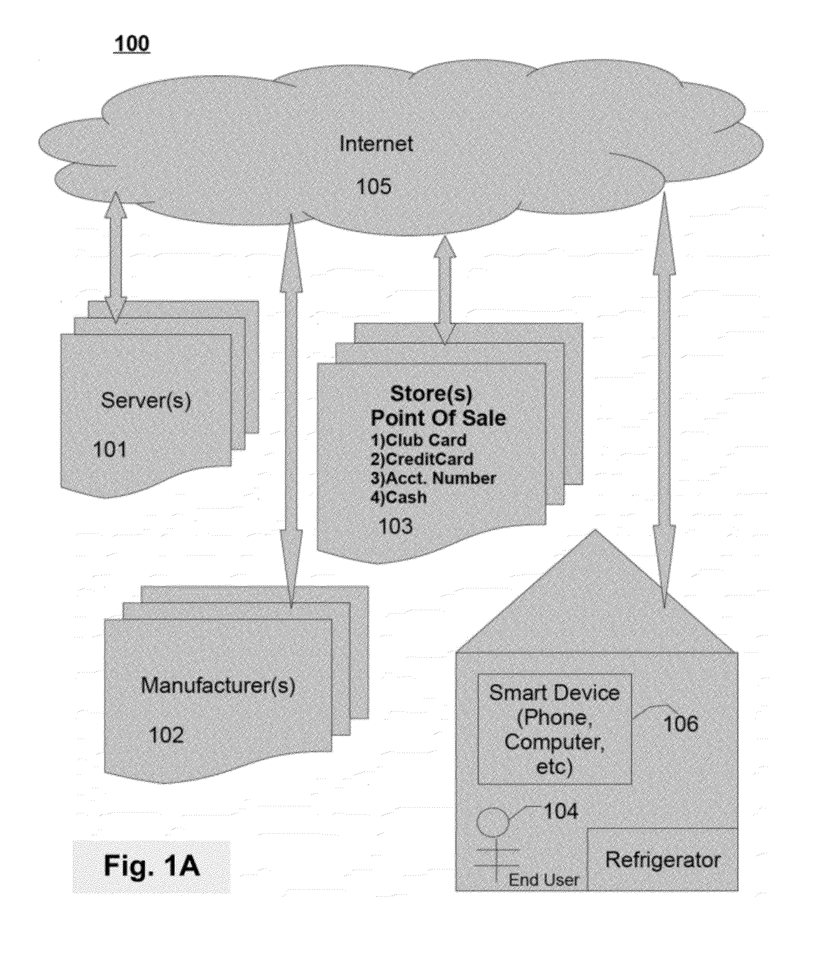

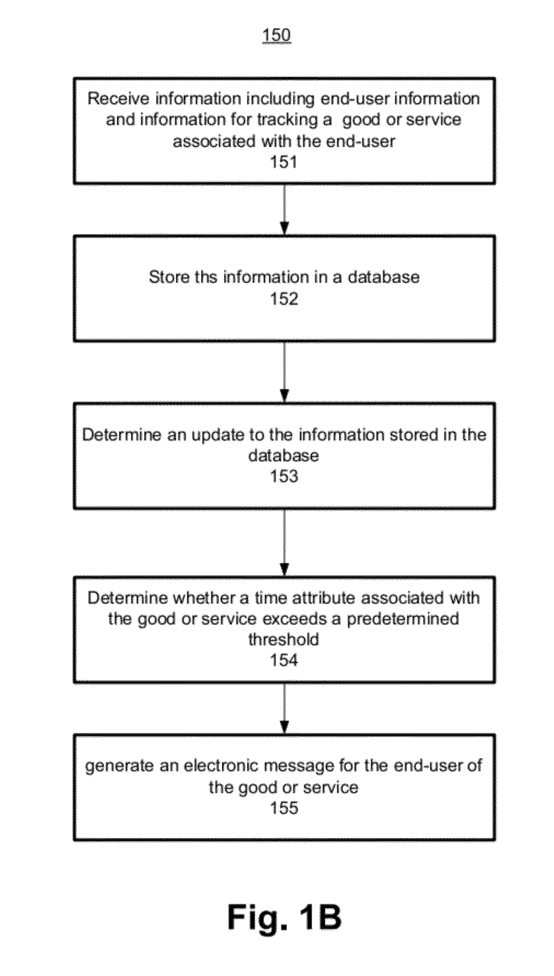

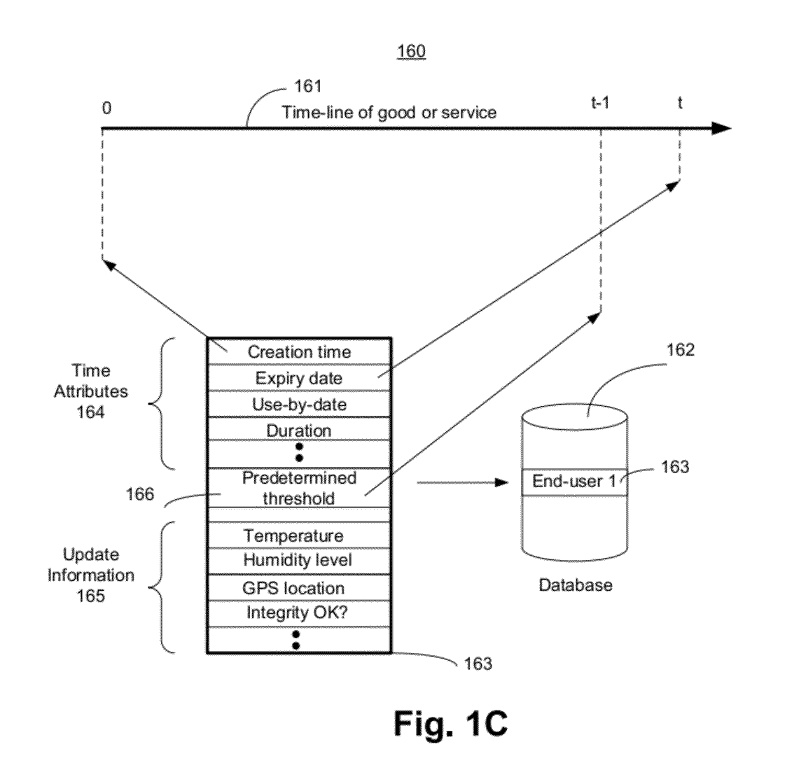

FIG. 1A illustrates a tracking system model 100 to track goods and services, according to one embodiment of the invention. In one embodiment, the tracking system model 100 comprises one or more servers 101 to store, manage, and process expiration dates of goods and services and all the associated information. In one embodiment, the one or more servers 101 comprise processing engines which are operable to track and create appropriate alerts, reminders and machine-to-machine data exchange messages associated with goods and services. In one embodiment, the one or more servers 101 are distributed over the network.

In one embodiment, the one or more servers 101 provide access to a customer-accessible information system to users 104 and manufacturers 102 so the users 104 and manufacturers can access real-time updates to information associated with good and services of interest. In one embodiment, the users 104 and manufacturers 102 can access the customer-accessible information system via the internet 104 by means of any computing device, e.g., a smart phone, tablet PC, etc.

In one embodiment, the servers 101 include software (machine executable instructions) that are configured to forward tracking information in the form of alerts/updates and/or reminders to end users 104. In one embodiment, the tracking information is forwarded to the end users 104 via email, short message service (SMS), calendar reminder events, etc. Alternatively, in one embodiment, such tracking information can be made available at predetermined websites e.g., Facebook®, Twitter®, or any other specific website) where a user 104 can login and review tracking information for an entire inventory of goods and services.

In one embodiment, the customer-accessible information system can aid as a shopping list creator, tracker, planner, etc. In one embodiment, expired items (goods and/or services) are automatically prompted via the tracking system to a user 104 for refill by the service providers of that in (goods and/or services). In one embodiment, the customer-accessible information system includes an integrated information system of, manufacturers 102, distributors, retailers 103, and consumers 104. In such an embodiment, the customer-accessible information system is effectively used in situations such as emergency recalls of items (goods and services) associated with such manufacturers 102, distributors, retailers 103, and consumers 104. In one embodiment, the customer-accessible information system is operable to communicate with users 104 via GPS services.

In one embodiment, a user 104 in the grocery store (or any other store) uses its GPS enabled smart-phone device 106, having computer executable instructions (a software program) to track goods and services, to interface with the customer-accessible information system. In such an embodiment, the GPS enabled smart-phone 106 is operable to intelligently prompt the user 104 of that smart-phone for any purchase of items from that grocery store regarding expiration of the item. In one embodiment, the tracking system to track goods and services is augmented with a service to show users 104 the competitive prices of items in nearby stores.

Alternatively, in one embodiment, the user 104 can enter tracking data (expiration date of goods and/or services) into the customer-accessible information system manually via its smart-phone 106 (or any other device). In one embodiment, the manual process of entering tracking data is replaced and/or augmented with scanners or voice recorders to enter tracking data to the customer-accessible information system.

In one embodiment, all the functions described herein are performed via smart phones 106. In one embodiment, the customer-accessible information system is operable to be accessed via an item recognition key, e.g., a product name, and information corresponding to the expiration of that item e.g., use by date. In one embodiment, the customer-accessible information system is operable to remind the user 104 about the expiration of goods and/or services associated for those items when the expiration of those goods and/or services is close to their ‘use-by’ date.

In one embodiment, the customer-accessible information system of the tracking system resides on the server 101. Alternatively, in one embodiment, the customer-accessible information system of the tracking system resides on a hand-held device, such as a smart-phone, and/or the server 101.

In one embodiment, the tracking system is operable to provide reminders to users 104 for scheduled intake of medicines. In such an embodiment, the combination of the expiration date tracking system with a system to remind users for scheduled intake of medicines avoids significant reduction in the risk associated with incorrect and/or expired medications. In one embodiment, the expiration tracking system is integrated with “coupon” systems for promotional purposes. In one embodiment, the expiration date tracking system is operable to remind the expiration of related items, i.e. items related to the items purchased or originally set to track for the user. For example, a user who bought a vehicle sets the tracking system described herein to track the expiration of warranties and/or recalls of that vehicle and can also track items related to that vehicle such as oil changes, vehicle tire rotations, license renewals, registration renewals, etc.

In one embodiment, the tracking system of FIG. 1A includes machine-to-machine intelligence. The term “machine-to-machine intelligence” herein refers to intelligent software executing on the machines (e.g., servers, smart devices, etc) that prompt a user about any updated information regarding the good or service when such update is deemed important to be sent.

In one embodiment, the machine-to-machine capabilities of the entire system 100 perform localized intelligence at each node (e.g., server 101, smart device 106) thus allowing distributed decision making as to when the user must be alerted to take an action. In such an embodiment, the combination of systems collectively keep the data updates and check for appropriate triggering of events based on prior location history of the item (good or service), various dates associated with the item (good or service), and various durations ascribed in the database, with respect to the current time and the current location of the (good or service being tracked.

In one embodiment, the triggering of the events could have multiple attributes which allow data to be updated on other servers 101 or smart device 106 (also called clients), or alternatively could result in user alert based on preset criterion at various nodes (e.g., other servers) the entire machine-to-machine sub-system. The machine-to-machine sub-system can typically include various smart-sensors, servers, client devices, embedded systems and servers, and are typically time-synchronized. The tracking system can further integrate with social networks such as Twitter®, Facebook®, etc.

In one embodiment, the machine-to-machine capabilities include features where user privacy of the user 104 is preserved. For example, a machine communicating with a second machine can create anew secure identity which allows the first machine to discern the user while simultaneously relaying the user specific, however, user un-identifiable, tracking information to subsequent machine for tracking purposes.

FIG. 1B is a flowchart 150 with additional methods to track goods and services by/for an end-user, according to one embodiment of the invention. Although the blocks in the flowchart 150 are shown in a particular order, the order of the actions can be modified. Thus, the illustrated embodiments can be performed in a different order, and some actions/blocks may be performed in parallel. Additionally, one or more actions/blocks can be omitted in various embodiments of tracking goods and services. FIG. 1B is described with reference to FIG. 1A.

In the embodiments discussed herein, the “user 104” is also referred to as the “end-user 104.” The term “end-user” herein refers to the entity at a point of consumption. For example, a distributor of the good or service; a point-of-sale facility of the good or service that buys the good or service from a distributor or an originating facility (e.g., factory), the person buying the good or service from the distributor or an originating facility (e.g., factory), or any other point-of sate facility, etc.

At block 151, the server 101 and/or the smart device 106 (e.g., PC Tablet, smart phone, etc) receives information about a good or service to be racked by the server 101 and/or by the smart device 106 accessible by the end-user. In one embodiment, the server 101 and/or smart device 106 receives end-user information corresponding to the end-user 104 associated with the good or service to be tracked.

For example, a consumer enters a retail shop and buys a widget. The tracking system, at the retailer and/or an application executing on a smart device 106 held by the consumer 104, sends the information to the server 101 and/or by the smart device 106 about the consumer and the widget bought by the consumer 104. In one embodiment, the information includes, user name, user address, user contact information (e.g., email, cell number), widget identification number (e.g., stock/inventory number), and any other widget information to identify the source of the widget.

In one embodiment, the information about the widget is tracked overtime by at least one of a radio-frequency identification (RFID) tag associated with the good or service; a thermal sensor for monitoring temperature associated with the widget; a humidity sensor for monitoring the humidity levels of the environment containing the widget; a shock sensor for monitoring real-time movement of the widget to determine integrity of the widget from an originating facility to the end-user; or a global positioning system (GPS) sensor to track movement of the widget from the originating facility to the end-user.

At block 152, the server 101 stores the information as an entry in a database. In one embodiment, the stored information is sorted and organized by end-user name and/or widget identity. FIG. 1C is a diagram 160 illustrating a time-line 161 indicating various time attributes 164 (e.g., expiration date, use-by-date, service-by-date, re-check-by-date, refill-by-date, re-order-by-date, etc) and update information 165 associated with the good or service that are stored as an entry 163 in a database 162, according to one embodiment of the invention. Entry 163 in FIG. 1C is one such example of an entry stored in the database.

Referring back to FIG. 1B, at block 153, the server 101 and/or the smart device 106 determines any update to the information stored about the good or service in the database. Continuing with the example above, the server 101 and/or the smart device 106 determines that the widget's useful life has expired and so the consumer of that widget should not use that widget for its intended purpose anymore. While the above example is given with reference to a widget, any good or service may be used instead of the widget without changing the essence of the embodiments of the invention.

Update information 165 in FIG. 1C is one such example of update information associated with the good or service stored in the database 162. The update information 165 is one or more of: a recall notice of the good by the manufacturer of the good or service; an expiration of useful life of the good or service; discount coupon for the good or service; competitive pricing of identical good or service; a temperature from the thermal sensor indicating that the temperature associated with the good crossed a threshold temperature level; a humidity level from the humidity sensor indicating that the humidity associated with the good crossed a threshold humidity level; an integrity information of the good from the shock sensor indicating that the good lost its integrity when being transported from the originating facility to the end-user; or a GPS movement information of the good indicating a detour path from the originating facility to the end-user. The above list of update information 165 is not intended to be an exclusive list. More attributes may be added as update information that pertains to the good or service of interest without changing the essence of the embodiments discussed herein.

Referring back to FIG. 1B, at block 154 the server 101 and/or the smart device 106 determines whether a time attribute associated with the good or service exceeds a predetermined threshold. Time attributes 164 and predetermined threshold 166 in FIG. 1C are one such example of time attributes and predetermined threshold stored in the database 162. In one embodiment, time attribute 164 is at least one of creation time, i.e., time when the good or service is bought or made, expiry date of the good or service, use-by date of the good or service, duration, i.e. how long the good or service has been in existence, etc. The above list of time attributes is not intended to be an exclusive list. More attributes may be added as time attributes (e.g., service-by-date, re-check-by-date, refill-by-date, re-order-by-date, etc) that pertain to the good or service of interest without changing the essence of the embodiments discussed herein. In one embodiment, the predetermined threshold 166 is a time quantity less than and/or equal to: the expiration date; the use-by-date, or any of the time attributes discussed above.

Referring back to FIG. 1B, at block 155, the server 101 and/or the smart device 106 generates an electronic message (e.g., email, Short Message Service, web-posting) for the end-user 104 of the good or service in response to determining the update to the good or service (e.g., one of the attributes of 165 in FIG. 1C is updated) or when the predetermined threshold (166 of FIG. 1C) exceed the time attribute 164.

In one embodiment, the method further comprises: determining whether the end-user 104 is registered with an originating facility or a point-of-sale facility, based on the received end-user 104 information; generating an entry in the database for the end-user 104 if the end-user 104 is unregistered with the originating facility or the point-of-sale facility; and setting permissions in the database 162 for sending the electronic message to the end-user 104. In one embodiment, the server 101 and/or the smart device 106 sends an update to members of the end-user 104, wherein the members of the end-user are identified with a common attribute among the members.

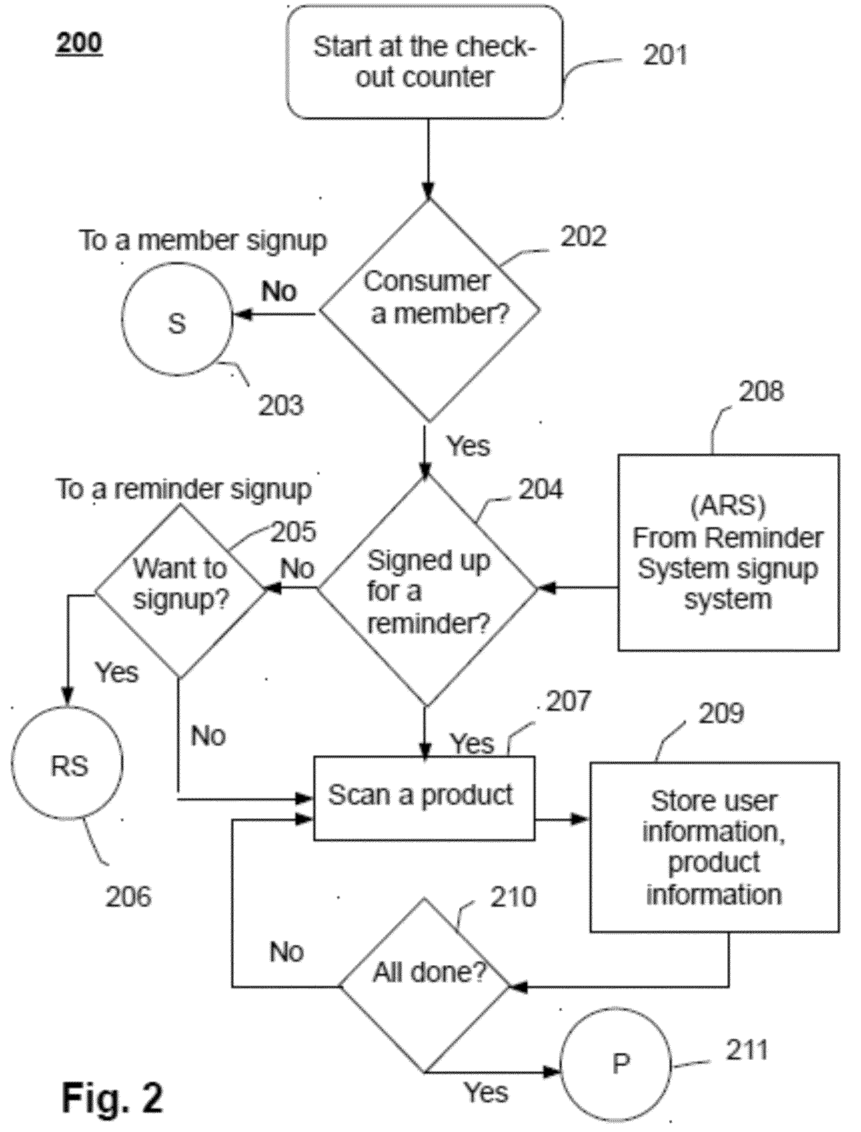

FIGS. 2-6 illustrate detailed flowcharts of the tracking system, according to one embodiment of the invention. The flowcharts are not limiting in any way to a particular example, but explain how the tracking system works according to one embodiment of the invention.

Although the blocks in the flowchart charts of FIGS. 2-6 are shown in a particular order, the order of the actions can be modified. Thus, the illustrated embodiments can be performed in a different order, and some actions/blocks may be performed in parallel. Additionally, one or more actions/blocks can be omitted in various embodiments of tracking goods and services.

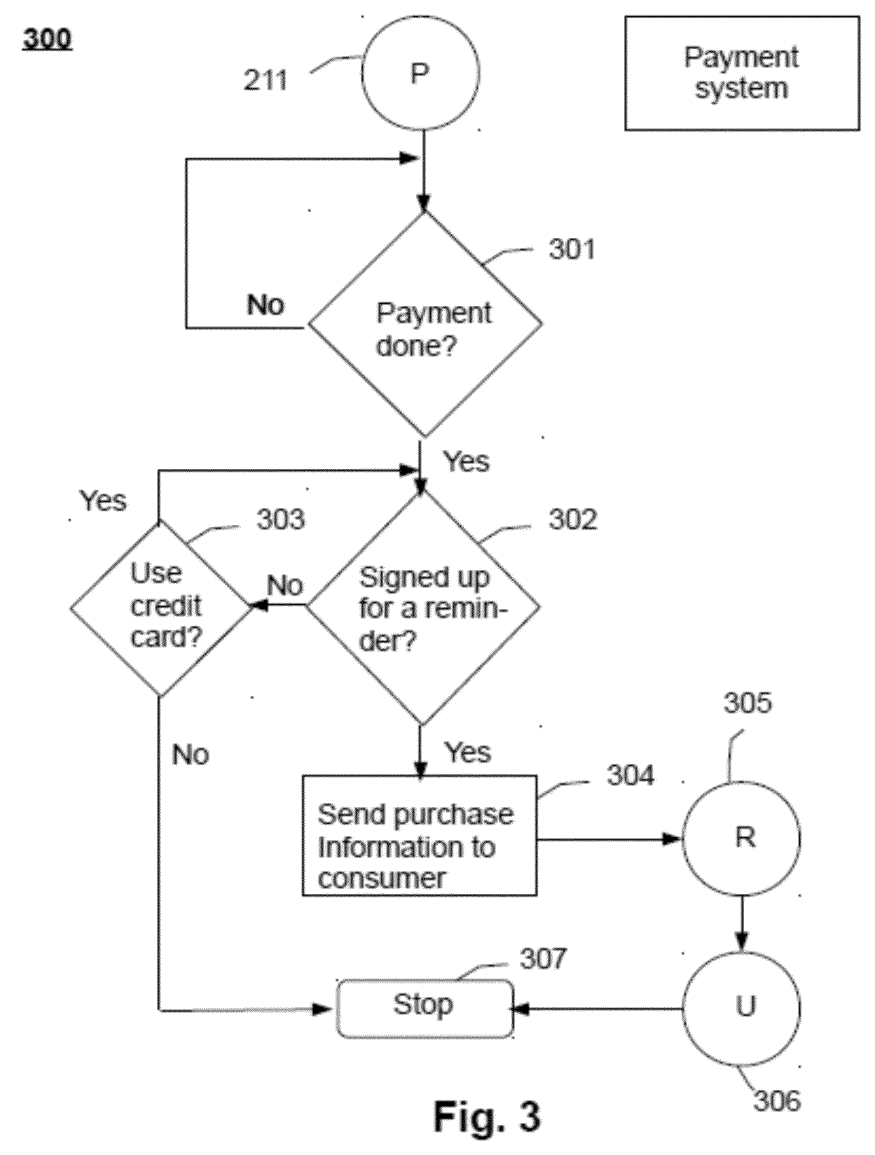

FIG. 2 illustrates a high level flowchart 200 of the tracking system, according to one embodiment of the invention. The flowchart 200 illustrates various components of the tracking system, for example, the member signup system 203, the reminder signup system 206/208 (discussed with reference to FIG. 5), and the payment system 211 (discussed with reference to FIG. 3). Some of the systems are implemented locally at a point-of-sale or an originating facility, white other systems are implemented in the server 101 and/or a smart device 106 accessible by the user 104.

At block 201, a user (or end-user) 104 checks out a good or service from a retailer 103 (point of sale) or manufacturer 102 (originating facility). The good or service is the item to be tracked (for any updates, e.g., expiration date of its useful life) by the tracking system, in one embodiment, the tracking system includes an electronic scanner that scans a bar code, associated with the good or service, at the retailer 103 (point of sale) or the manufacturer 102 (originating facility).

At block 202, the tracking system determines whether the user 104 associated with the to-be tracked good or service is a member of the retailer 103 or manufacturer 102 from where the good or service is being checked out. If a determination is made that the user 104 is not a member, then an offer is made at block 203 to sign-up the user 104 as a member of the retailer 103 or manufacturer 102 so that the user 104 has the opportunity to use the tracking system to track its goods or services. The term “member” in the above context refers to member of the retailer 103 (point of sale) or manufacturer 102 (originating facility), e.g., Costco Warehouse membership, retailer credit card membership, club card membership, etc.

If a determination is made that the user 104 is a member of the retailer 103 or manufacturer 102, then at block 204 a determination is made whether the user 104 and/or the retailer 103 or manufacturer 102 is signed up with the tracking system for receiving reminders/updates about the checked out good or service. In one embodiment, the tracking system invokes the reminder system 208 to determine whether the user 104 has signed up with the reminder system 206. If the user 104 is signed up for receiving reminders/updates associates with the checked out good or service the process proceeds to scanning the good or service for payment at block 207.

At block 205, the user 104 is given a choice about signing up for tracking the checked-out good to service if the user 104 has not signed up for receiving reminders at block 204. If the user 104 decides to track the good or service, then the reminder system is invoked at block 206. If the user 104 decides not to track the good or service, then the reminder system is not invoked and the good or services is simply scanned at block 207 and no reminders are sent via the tracking system to the end-user 104.

At block 209, the scanner (manual or electronic) stores information about the checked out good or service for its internal records and for the tracking system if the user 104 is signed up for the reminders related to the checked out good or service. The process of buying the good or services is then complete as indicated by block 210. If the user 104 wants to buy more goods or services, then the good or service is scanned at 207, or alternatively the user 104 is given an opportunity to track the new good or service at blocks 202 or 205. At block 211, a payment system is initiated and the user 104 pays for the checked-out good or service.

FIG. 3 illustrates a method flowchart 300 of the payment system 211 to enable tracking of goods and services, according to one embodiment of the invention. At block 301 a determination is made whether a payment has been made by the user 104 (or any other entity besides the user 104 for the user 104). In one embodiment, the payment system 211 comprises a scanner coupled to a cash register or credit card swipe machine. In one embodiment, the payment system 211 is a credit card swipe/scan machine.

At block 302, the user 104 is given the opportunity to sign up for receiving a reminder/update corresponding to the checked-out good or service or any other good or service previously bought from that retailer 103 or manufacturer 102. If the user 104 is signed up for receiving reminders/updates regarding the good or service being checked out (or paid for), then at block 304 purchase information is sent to the user 104 and the reminder system 1305 is enabled for the user 104. At block 306, the user system 306 is also enabled that allows a user 104 to set up user preferences and identity setting for receiving reminders/updates. At block 307 the payment system 300 completes its process.

At block 302 if a determination is made that the user is not signed up for receiving reminders then the user 104 is given an opportunity to sign up for reminders again at block 303 if the user is using the member credit card associated with the retailer 103 or manufacturer 102. If the user is not using the member credit card associated with the retailer 103 or manufacturer 102 then the payment system completes at block 307.

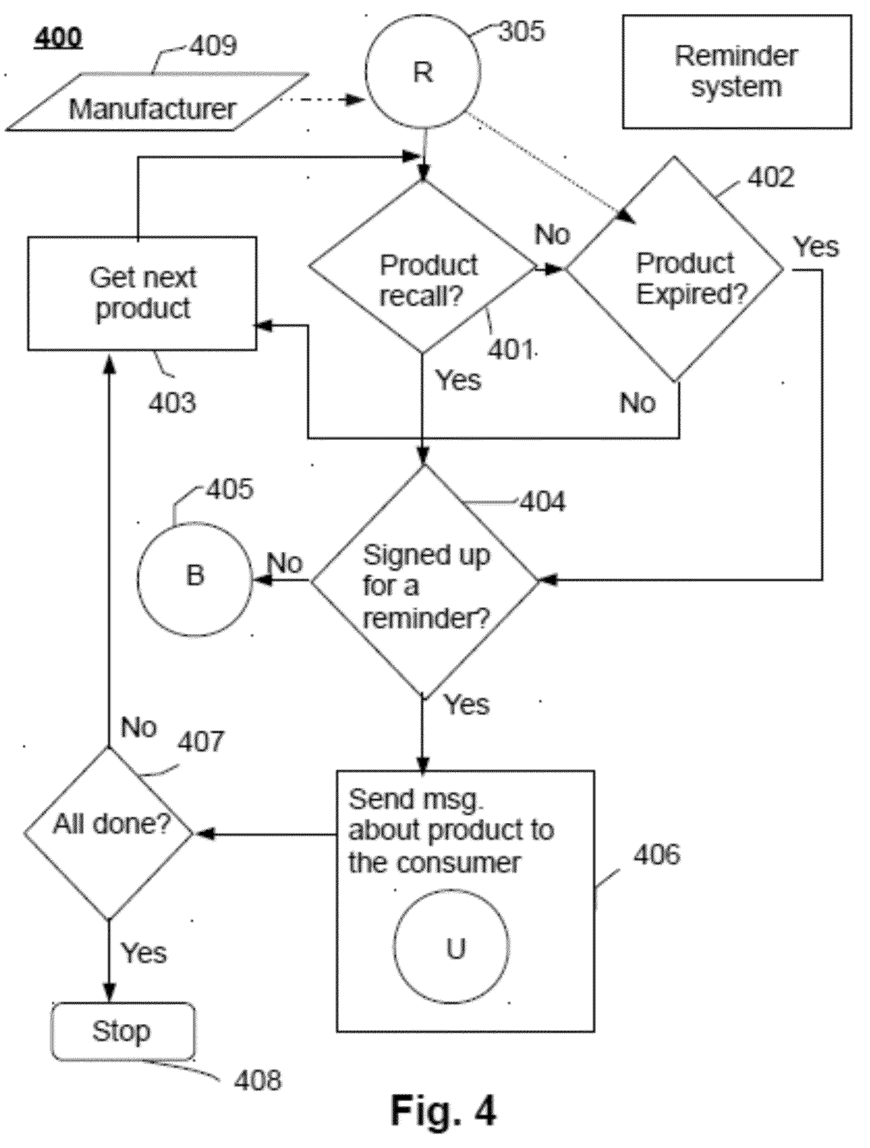

FIG. 4 illustrates a method flowchart 400 of a reminder system to remind a user or an entity about the goods and services being tracked, according to one embodiment of the invention. In one embodiment, the manufacturer 409 of the good or service may sign up with the reminder system for the good or service it offers to its customers. The reminder system can be setup to generate any kinds of reminders associated with the good or service of interest. For example, the reminder system may send reminder messages about a product recall, an expiration of the useful life of the product, etc.

At block 401, a determination is made about any recall notices (i.e., updates) issued about the good or service of interest. If a determination is made that the good or service is being recalled, then the process proceeds to block 404 discussed below.

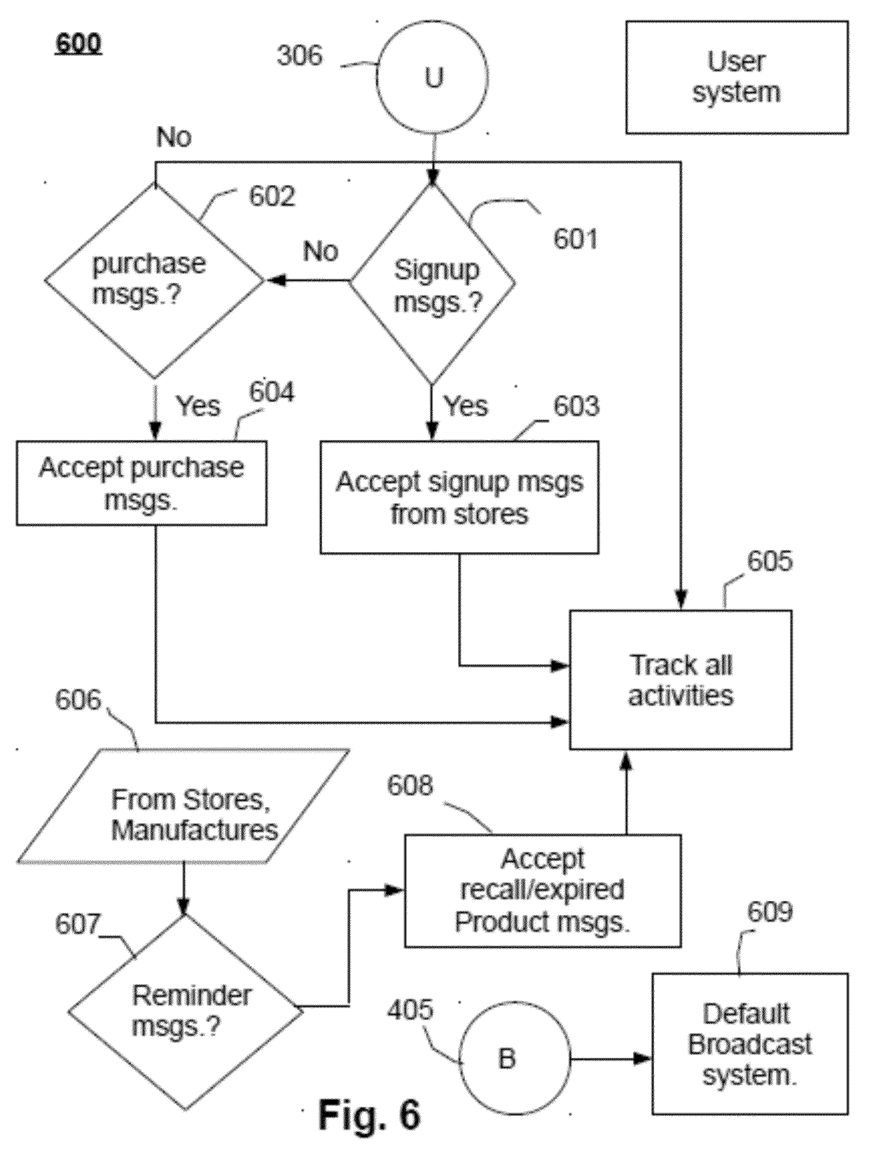

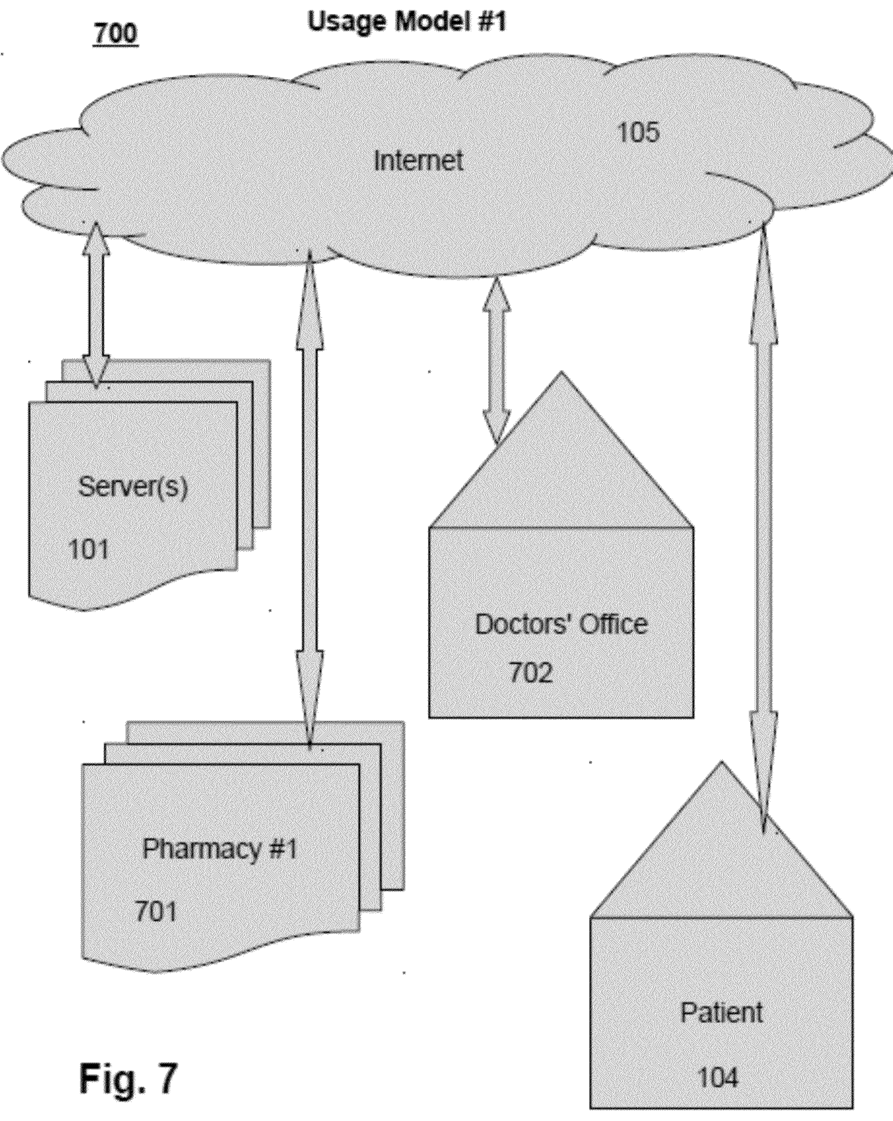

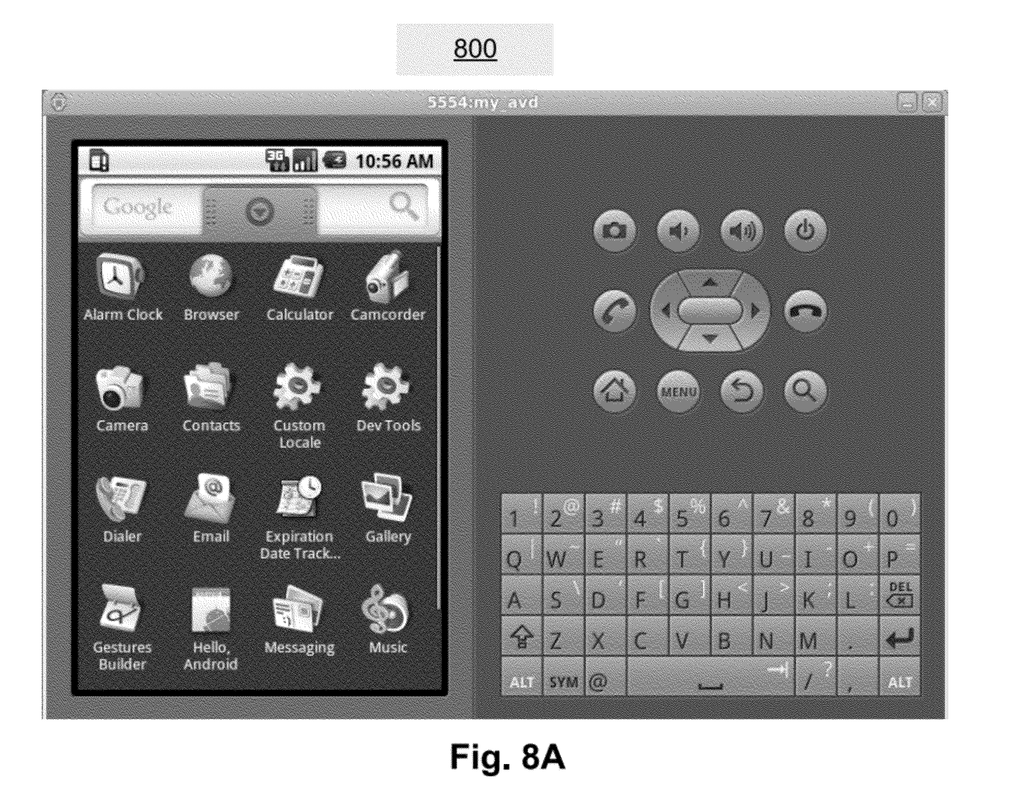

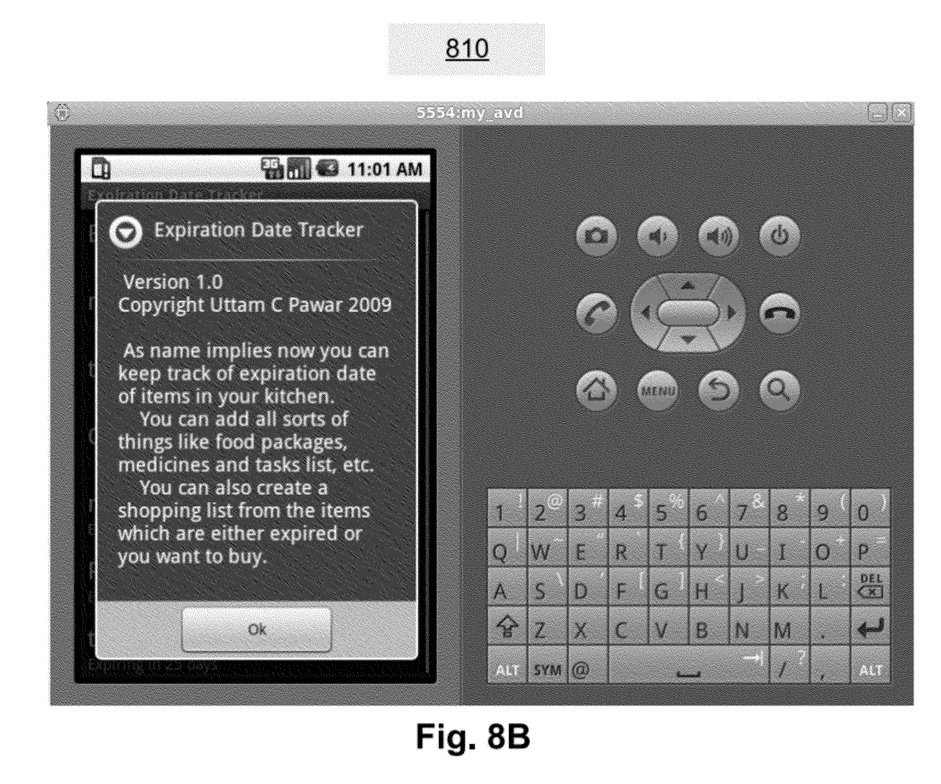

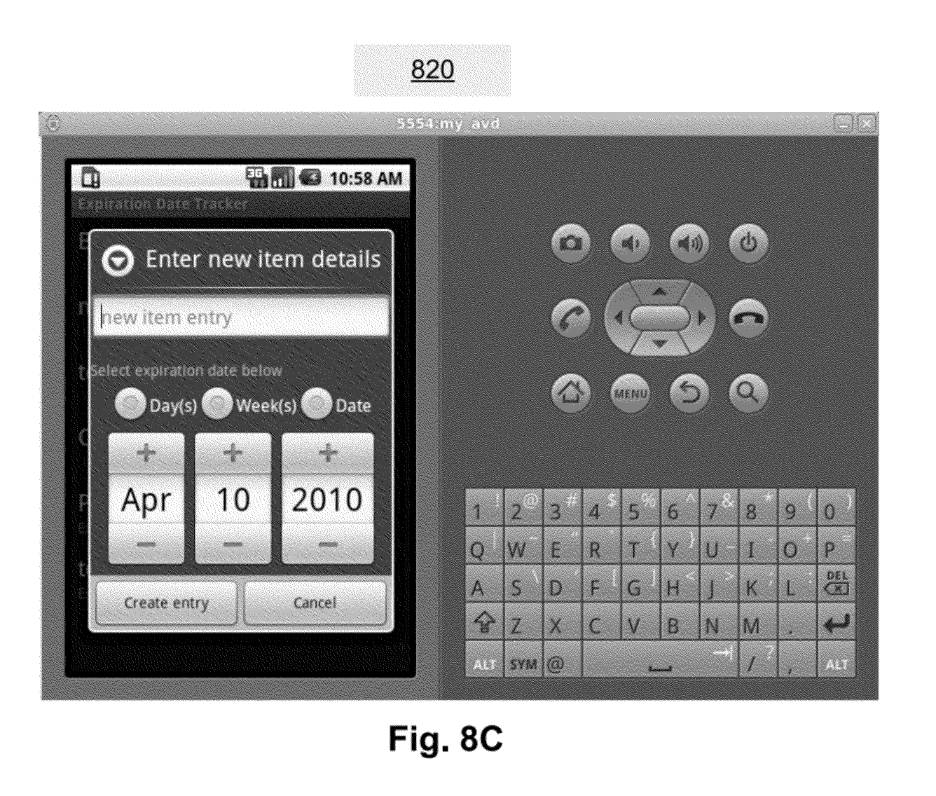

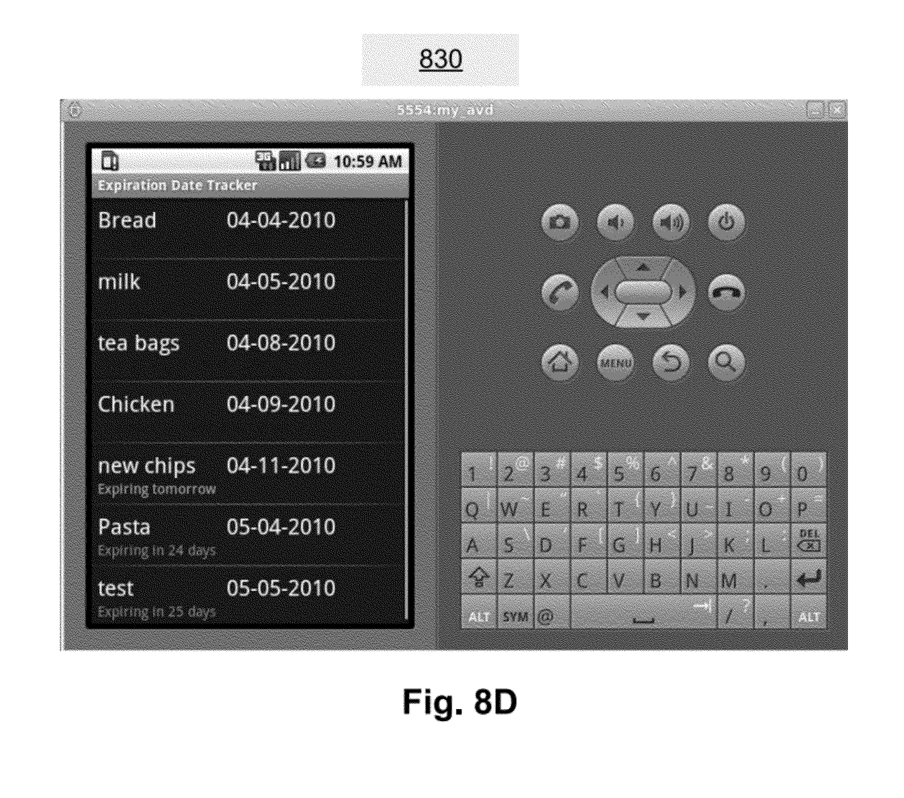

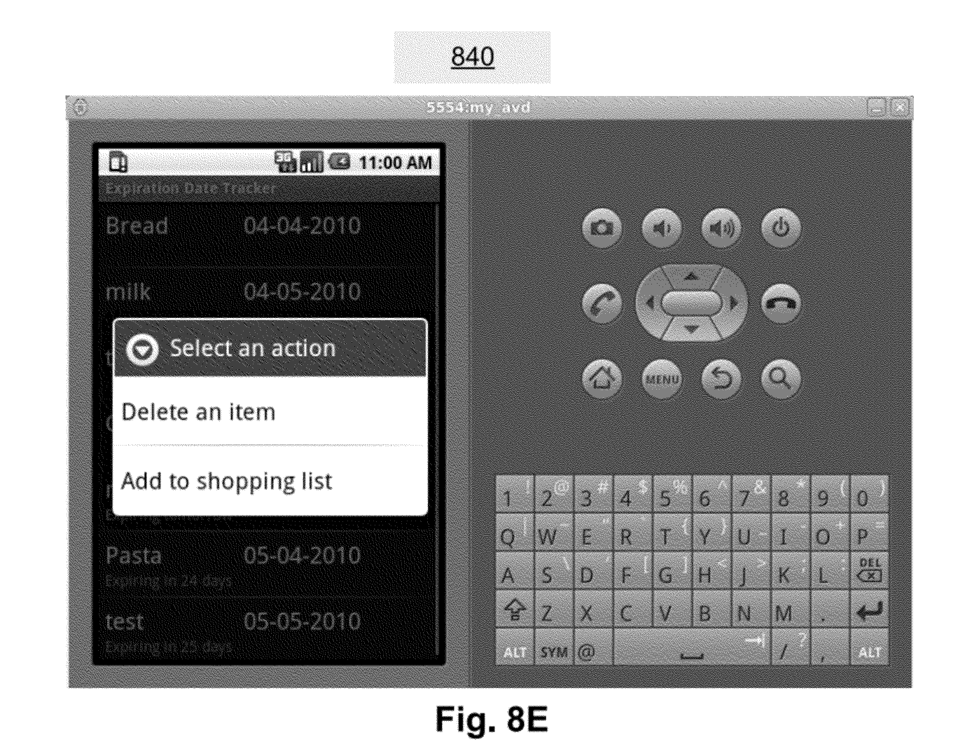

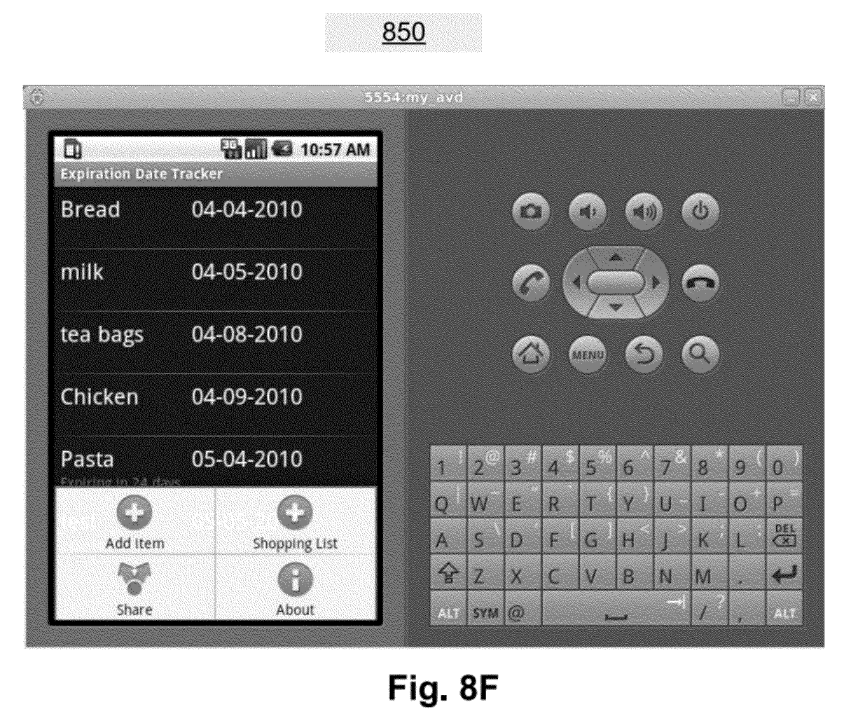

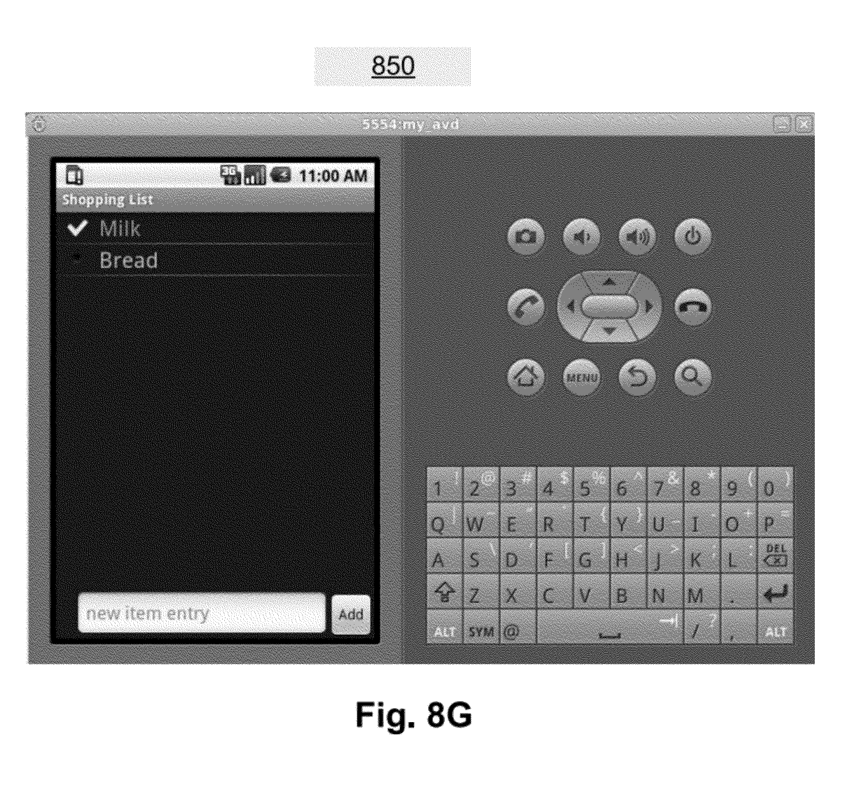

At block 402, a determination is made about the expiration date associated with the good or service. If the good or service of interest is expired, then at block 404 a determination is made whether the user 104 and/or manufacturer 409 of that good or service has signed up for receiving reminders associated with the good or service. If the user 104 and/or manufacturer 409 has not signed up for receiving reminders, then any update or alert associated with the good or service is broadcast at block 405 on social network websites to put the general population on notice about the update or alert. In one embodiment, there are two ways that result in broadcasting the update or alert to the social networks. First, when the end-user 104 chooses to do it by signing up with the reminder system. Second, when the end-user 104 is not signed up but as a social responsibility, the tracking system broadcasts any recall/update/alert information from and for clients (retailers, manufacturer's, etc) for the benefit of the general population. The lower part of FIG. 6 shows the broadcast system 609, according to one embodiment of the invention. The broadcast system is the default system of sending out general notices/updates/alerts, regarding the good or service, to a social networking website.

Referring back to FIG. 4, if a determination is made that the good or service is not expired, then the reminder system proceeds to the next good or service in the list for the user 104 and/or manufacturer 409. If a determination is made that the end-user 104 and/or manufacturer 409 has signed up, then the reminder system sends an electronic message to the end-user 104 at block 406. This message may be sent to a handheld device accessible to the end-user 104. Alternatively, the message may be sent to predetermined websites (e.g., Facebook®, Twitter®, etc).

At block 407, a determination is made whether the reminder system has processed reminders for all goods or services associated with the end-user 104. If a determination is made that there are more goods or services that need to be checked for recalls or expirations, then the process continues to block 403, else the process stops at block 408.

FIG. 5 illustrates a method flowchart 500 of a reminder signup system for tracking of goods and services, according to one embodiment of the invention. The reminder signup system discussed with reference to FIG. 5 is located at the point of consumption, e.g., point-of-sale retail stores, originating facility, credit card companies, etc. In one embodiment, the reminder signup system is invoked when an end-user 104 wants to sign up for receiving electronic reminders as shown by block 206 of FIG. 2. In one embodiment, the reminder signup system is invoked when the end-user 104 wants to sign up for becoming a member as shown by block 203 of FIG. 1

At block 501, a determination is made whether the end-user 104 agrees to share personal information. If the end-user 104 agrees to share personal information then at block 503, its information is included and/or updated. In one embodiment, the information is included and/or updated in the server 101 and/or the smart device 106. In one embodiment, the information includes name, address, phone number, email address, Twitter® identification, Facebook® identification, etc.

At block 504, the reminder signup system sends a confirmation to the end-user 104 about successfully signing up with the reminder signup system. The process then continues with the purchase mode at block 505. If the end-user 104 wants to continue purchases of goods or services, the process proceeds to block 208, or else the process stops at 506.

At block 502, a determination is made whether the end-user 104 and/or manufacturer 102 agree to become a member. If the end-user 104 and/or manufacturer 102 want to become a member, then the process continues to block 501 as discussed above. If the end-user 104 does not want to become a member, then it does not want to receive reminders and may continue with its purchases as indicated by block 505.

FIG. 6 illustrates a method flowchart 600 of a user system to track goods and services, according to one embodiment of the invention. The user system may be invoked by the end-user 104.

At block 601, a determination is made whether the end-user 104 has signed up for receiving reminder messages. If the end-user 104 has not signed up for receiving reminder messages, then the end-user 104 is offered two models of receiving reminder messages at block 602. If the end-user 104 purchases a reminder model, i.e. pays a premium for the reminder messages, then the end-user 104 is asked to formally accept the purchase plan at block 604. The process then proceeds to block 605 to track all goods or services associated with the end-user 104.

If the end-use 104 does not purchase the reminder model, then a basic tracking of goods and services is performed for the end-user at block 605. The premium reminder model may include tracking of more attributes of the good or service, and personalized on-line and off-line customer service. Conversely, the basic reminder model provides tracking of one or two attributes of the good or service, and non-personalized on-line customer service.

If the end-user 104 has signed up for receiving reminder messages, then the end-user 104 also accepts receiving messages from the retail store it bought the good or service, as indicated at 603.

In one embodiment, the end-user 104 invokes the user system at a store 606—point of sale or originating facility. At block 607, the end-user 104 is asked whether the end-user 104 would like to receive reminder messages associated with the good or service of interest. If the end-user 104 does not want to receive reminder messages, then the end-user 104 continues with the payment of the good or service and the process concludes. If the end-user 104 would like to signup for reminder messages, then the end-user 104 accepts receiving such messages (e.g., recall message, expiry message, etc) at block 608. The process then continues to block 605 where the good or service of interest is tracked.

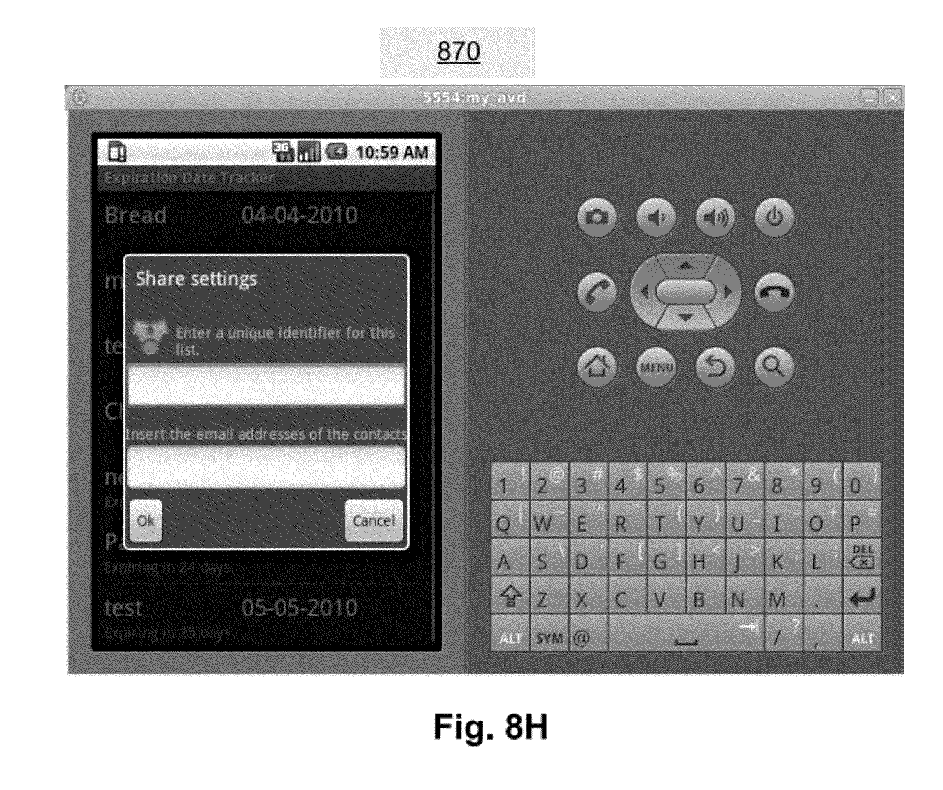

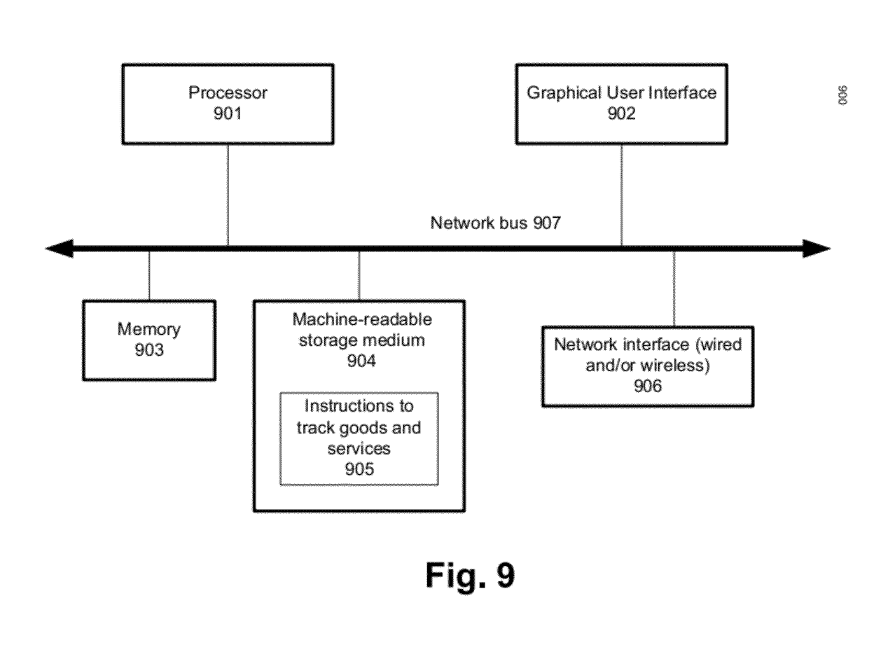

FIG. 7 illustrates a tracking system model 700 for the pharmaceutical industry, according to one embodiment of the invention. In one embodiment, the server 101 and/or the smart device 106 track the expiration dates of a drug supplied to the patient 104, doctor's office 702, and/or the pharmacy 701. In one embodiment, the server 101 and/or the smart device 106 also track any messages from the U.S. Food and Drug Administration (FDA) about the drugs supplied to the patient 104, doctor's office 702, and/or the pharmacy 701. In the embodiments discussed herein the server 101 and/or the smart device 106 provides tracking information to the patient 104, doctor's office 702, and/or the pharmacy 701 via the internet 105.

FIG. 8A-H illustrate a graphical user interface of the tracking system on a smart device 106 that is used to update customer-accessible information and to provide tracked information to the end-user 104, according to one embodiment of the invention. FIG. 8A illustrates a start-up user interface 800 of an Andriod® based smart phone executing one or more methods described and/or illustrated herein, according to one embodiment of the invention. FIG. 8B illustrates an information screen 810 of the tracking system, according to one embodiment of the invention. FIG. 8C illustrates a user interface 820 to manually enter information about the items to be tracked, according to one embodiment of the invention. FIG. 8D is a screen shot 830 of a smart device showing expiration dates of various items being tracked by the tracking system, according to one embodiment of the invention. FIG. 8E is a screen shot 840 of the smart device showing the ability to add or delete an item to be tracked, according to one embodiment of the invention. FIG. 8F is a screen shot 850 of the smart device showing the ability to share the tracked items with other users and systems, according to one embodiment of the invention. FIG. 8G is a screen shot 860 showing the ability to update items on a checklist as the user buys or discards those items, according to one embodiment of the invention. FIG. 8H is a screen shot 870 showing simultaneous and concurrent sharing of shopping lists via sharing mechanisms such as email, texting, and dynamic content management.

FIG. 9 illustrates a system 900 with a machine-readable storage medium 904, according to one embodiment of the invention. The flowcharts of the tracking system discussed above are implemented as computer executable instructions 905 that are stored on a memory as machine-readable (or computer executable) instructions that when executed cause a processor in the tracking system to execute the instructions. The system 900 comprises a graphical user interface 902 to send and receive messages associated with the computer executable instructions 905 executed by a processor 901. The system also comprises memory 903 for storing data, and a network interface 906 to connect the system 900 to the internet. The components of the system 900 may communicate with one another via a network bus 907.

The elements of embodiments are also provided as machine-readable storage medium 904 for storing the computer-executable instructions 905. The machine-readable storage medium 904 may include, but is not limited to, flash memory, optical disks, CD-ROMs, DVD ROMs, RAMs, EPROMs, EEPROMs, magnetic or optical cards, or other type of machine-readable storage media suitable for storing electronic or computer-executable instructions 905. In one embodiment, these computer-executable instructions 905 include instructions that execute the methods discussed above and described in FIGS. 1-6.

The techniques shown in the figures can be implemented using code and data stored and executed on one or more electronic devices (e.g., an end station, a network element, a smart phone, a PC tablet, a server). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices 902 (e.g., a keyboard, a touch screen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

Embodiments of the invention may be downloaded as a computer program which may be transferred from a remote computer (e.g., a server) to a requesting computer (e.g., a client) by way of data signals via a communication link 906 (e.g., a modem or network connection).

In one embodiment, the customer-accessible information of the tracking system is integrated with social networks such as Twitter®, Facebook®, etc., to quickly (or in real-time) propagate critical issues regarding the items being tracked by the tracking system. For example, a critical issue regarding an item such as a recall notice for an item which is posted on a social network is propagated via the tracking system to the customer-accessible information. In such a case, the end user is informed by the tracking system about the recall of the item which would otherwise not get the user's attention.

In an alternative embodiment, under appropriate personal security preferences, the tracking system is operable to propagate information about individual purchases of goods and/or services publicly or to specific subset of user preferred social network. In such an embodiment, the items (goods and/or services) are openly tracked by other users (individuals and/or computers) for not just the expiration of the items but also the quality of the items annotated by the original user purchaser of the item.

In one embodiment, the tracking system is configured to use secure keys to provide security and/or privacy to users using the tracking system on the Internet. In one embodiment, the secure keys are based unidirectional authentication. In such an embodiment, the end-user of the tracking system can uniquely identify relevant information (e.g., expiration date, warranty date, recall date, use-by date, etc) related to the items being tacked via unique keys and passwords. In one embodiment, forward traceability of the tracking system by all other entities is made impossible. In one embodiment, the tracking system is operable to use multiple layers for authentication and unification of the customer-accessible information and the communications with the tracking system. In one embodiment, for a unique instance of an item in the customer-accessible information database, the fields of the database get augmented from its original creation through an entire chain of the entities until the item is expired.

In one embodiment, the tracking system is operable to allow an end-user of the tracking system to pay directly for the services of the tracking system. In one embodiment, the tracking system is configured to be downloaded to a mobile smart phone 106 as a smart-phone application. In one embodiment, the smart-phone application of the tracking system is operable to be used on a one-time fee basis. In one embodiment, the smart-phone application of the tracking system is operable to be used on a subscription fee basis allowing extended services with intelligent machine-to-machine information systems. In such an embodiment, the subscription based offerings of the tracking system provides optimum monetization pathways to the end-user of the tracking system by providing maximal service value at the minimum cost.

The term “optimum monetization pathway” herein refers to balancing of the value (measured by end-user satisfaction) of the tracking system service to an end-user of the tracking system with the cost as measured by a subscription fee of the tracking system.

In one embodiment, the tracking system is operable to charge and process a fee from the manufacturers, distributors, advertisers, retailers, maintenance service providers, credit service providers, and/or banking systems for the goods and/or services being tacked.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While the invention has been described in conjunction with specific embodiments thereof, many alternatives, modifications and variations of such embodiments will be apparent to those of ordinary skill in the art in light of the foregoing description.

We claim:

1. A computer implemented method for tracking a good or service, the method comprising:
storing information in a database, the information corresponding to the good or service being tracked for an end-user;
determining an update to the information stored in the database;
determining whether a time attribute associated with the good or service exceeds a predetermined threshold; and
generating an electronic message for the end-user of the good or service in response to determining the update or when the predetermined threshold exceeds the time attribute.

2. The method of claim 1, where the time attribute is at least one of:
expiration date,
use-by-date,
service-by-date,
re-check-by-date,
refill-by-date, or
re-order-by-date.

3. The method of claim 2, wherein the predetermined threshold is a time quantity less than:
the expiration date,
the use-by-date,
the service-by-date,
the re-check-by-date,
the refill-by-date, or
the re-order-by-date.

4. The method of claim 1, wherein the information corresponding to the good or service is tracked from an originating facility to the end-user, wherein end-user is one of:
a distributor of the good or service;
a point-of-consumption of the good or service; or
a point-of-sale facility of the good or service.

5. The method of claim 1 further comprises:
prior to sending the electronic message, receiving end-user information including the information of good or service;
determining whether the end-user is registered with the originating facility or a point-of-sale facility;
generating an entry in the computer database for the end-user if the end-user is unregistered with the originating facility or the point-of-sale facility; and
setting permissions in the database for sending the electronic message to the end-user.

6. The method of claim 1, wherein the information corresponding to the good or service is tracked overtime by at least one of:
a radio-frequency identification (RFID) tag associated with the good or service;
a thermal sensor for monitoring temperature associated with the good;
a humidity sensor for monitoring the humidity levels of the environment containing the good;
a shock sensor for monitoring real-time movement of the good to determine integrity of the good from the originating facility to the end-user; or
a global positioning system (GPS) sensor to track movement of the good from the originating facility to the end-user.

7. The method of claim 6, wherein determining the update comprises receiving one or more of:
a temperature from the thermal sensor indicating that the temperature associated with the good crossed a threshold temperature level;
a humidity level from the humidity sensor indicating that the humidity associated with the good crossed a threshold humidity level;
an integrity information of the good from the shock sensor indicating that the good lost its integrity when being transported from the originating facility to the end-user; or
a GPS movement information of the good indicating a detour path from the originating facility to the end-user.

8. The method of claim 1 further comprises, in response to generating the electronic message for the end-user: performing at least one of:
sending the electronic message to a predetermined website on the Internet for the end-user to review the update; or
sending the electronic message to a smart device accessible to the end-user.

9. The method of claim 1, wherein the update is one or more of:
a recall notice of the good by the manufacturer of the good or service;
an expiration of useful life of the good or service;
discount coupon for the good or service; or
competitive pricing of identical good or service.

10. The method of claim 1 further comprises, in response to generating the electronic message for the end-user:
sending the update to members of the end-user, wherein the members of the end-user are identified with a common attribute among the members.

11. A computing device for tracking good or service, the computing device comprising:
a memory; and
a processor, coupled to the memory, having logic that is operable to perform a method comprising:
storing information in a database, the information corresponding to the good or service being tracked for an end-user;
determining an update to the information stored in the database;
determining whether a time attribute associated with the good or service exceeds a predetermined threshold; and
generating an electronic message for the end-user of the good or service in response to determining the update or when the predetermined threshold exceeds the time attribute.

12. The computing device of claim 11, where the time attribute is at least one of:
expiration date,
use-by-date,
service-by-date,
re-check-by-date,
refill-by-date, or
re-order-by-date; and
wherein the predetermined threshold is a time quantity less than:
the expiration date,
the use-by-date,
the service-by-date,
the re-check-by-date,
the refill-by-date, or
the re-order-by-date.

13. The computing device of claim 11, wherein the information corresponding to the good or service is tracked from an originating facility to the end-user, wherein end-user is one of:
a distributor of the good or service;
a point-of-consumption of the good or service; or
a point-of-sale facility of the good or service, and
wherein the update is one or more of:
a recall notice of the good by the manufacturer of the good or service;
an expiration of useful life of the good or service;
discount coupon for the good or service; or
competitive pricing of identical good or service.

14. The computing device of claim 11, wherein the information corresponding to the good or service is tracked overtime by at least one of:
a radio-frequency identification (RFID) tag associated with the good or service;
a thermal sensor for monitoring temperature associated with the good;
a humidity sensor for monitoring the humidity levels of the environment containing the good;
a shock sensor for monitoring real-time movement of the good to determine integrity of the good from the originating facility to the end-user; or
a global positioning system (GPS) sensor to track movement of the good from the originating facility to the end-user.

15. The computing device of claim 14, wherein determining the update comprises receiving one or more of:
a temperature from the thermal sensor indicating that the temperature associated with the good crossed a threshold temperature level;
a humidity level from the humidity sensor indicating that the humidity associated with the good crossed a threshold humidity level;
an integrity information of the good from the shock sensor indicating that the good lost its integrity when being transported from the originating facility to the end-user; or
GPS movement information of the good indicating a detour path from the originating facility to the end-user.

16. An article of manufacture comprising machine-readable storage medium having computer executable instructions stored thereon that, when executed, cause a machine to perform a method for tracking good or service, the method comprising:
storing information in a database, the information corresponding to the good or service being tracked for an end-user;
determining an update to the information stored in the database;
determining whether a time attribute associated with the good or service exceeds a predetermined threshold; and
generating an electronic message for the end-user of the good or service in response to determining the update or when the predetermined threshold exceeds the time attribute.

17. The article of manufacture of claim 16, where the time attribute is at least one of:
expiration date,
use-by-date,
service-by-date,
re-check-by-date,
refill-by-date, or
re-order-by-date;
wherein the predetermined threshold is a time quantity less than:
the expiration date,
the use-by-date,
the service-by-date,
the re-check-by-date,
the refill-by-date, or
the re-order-by-date;
wherein the information corresponding to the good or service is tracked from an originating, facility to the end-user, and
wherein end-user is one of:
a distributor of the good or service;
a point-of-consumption of the good or service; or
a point-of-sale facility of the good or service.

18. The article of manufacture of claim 16, wherein the machine-readable storage medium includes further computer executable instructions stored thereon that, when executed, cause the machine to perform a method further comprising, in response to generating the electronic message for the end-user, sending the update to members of the end-user, wherein the members of the end-user are identified with a common attribute among the members.

19. The article of manufacture of claim 16, wherein the information corresponding to the good or service is tracked overtime by at least one of:
a radio-frequency identification (RFID) tag associated with the good or service;
a thermal sensor for monitoring temperature associated with the good;
a humidity sensor for monitoring the humidity levels of the environment containing the good;
a shock sensor for monitoring real-time movement of the good to determine integrity of the good from the originating facility to the end-user; or
a global positioning system (GPS) sensor to track movement of the good from the originating facility to the end-user.

20. The article of manufacture of claim 16, wherein determining the update comprises receiving one or more of:
a temperature from the thermal sensor indicating that the temperature associated with the good crossed a threshold temperature level;
a humidity level from the humidity sensor indicating that the humidity associated with the good crossed a threshold humidity level;
an integrity information of the good from the shock sensor indicating that the good lost its integrity when being transported from the originating facility to the end-user; or
a GPS movement information of the good indicating a detour path from the originating facility to the end-user.
